(19) United States
(12) Patent Application Publication
(10) Pub. No.: US 2022/0305625 A1
(43) Pub. Date: Sep. 29, 2022

(54) IMPACT TOOL

(71) Applicant: MAKITA CORPORATION, Anjo-shi (JP)

(72) Inventor: Yasuhito KAWAI, Anjo-shi (JP)

(73) Assignee: MAKITA CORPORATION, Anjo-shi (JP)

(21) Appl. No.: 17/684,850

(22) Filed: Mar. 2, 2022

(30) Foreign Application Priority Data
Mar. 29, 2021 (JP) 2021-055797

(51) Int. Cl. B25B 21/02

(52) U.S. Cl. CPC B25B 21/02; B25F 5/001

(57) ABSTRACT

An impact tool has a smaller diameter in its portion around a front end of an anvil. The impact tool includes a motor, a hammer rotatable by the motor, an anvil having a tool hole to receive a tip tool and being strikable by the hammer in a rotation direction and having a ball hole, a ball movable, through the ball hole, between an entered position at which the ball is at least partially inside the tool hole and a retracted position at which the ball is outside the tool hole, and at least one button operable to move the ball radially.

### CROSS-REFERENCE TO RELATED APPLICATIONS

This application claims the benefit of priority to Japanese Patent Application No. 2021-055797, filed on Mar. 29, 2021, the entire contents of which are hereby incorporated by reference.

### BACKGROUND

### 1. Technical Field

The present disclosure relates to an impact tool.

### 2. Description of the Background

An impact tool includes an anvil and a tool holder, such as a chuck sleeve, for holding a tip tool attached to the anvil. An impact driver described in Japanese Patent No. 4917408 has a shorter axial length than an impact driver including a chuck sleeve.

### BRIEF SUMMARY

To improve operability and working efficiency, an impact tool is to have a smaller diameter in its portion around a front end of an anvil.

One or more aspects of the present disclosure are directed to a structure with a smaller diameter in a portion around a front end of an anvil.

A first aspect of the present disclosure provides an impact tool, including:

a motor;

a hammer rotatable by the motor;

an anvil having a tool hole to receive a tip tool, the anvil being strikable by the hammer in a rotation direction and having a ball hole;

a ball movable, through the ball hole, between an entered position at which the ball is at least partially inside the tool hole and a retracted position at which the ball is outside the tool hole; and

at least one button operable to move the ball radially.

The impact tool according to the above aspect of the present disclosure has a smaller diameter in its portion around the front end of the anvil.

### BRIEF DESCRIPTION OF DRAWINGS

FIG. 1 is a perspective view of an impact tool according to an embodiment.

FIG. 2 is a side view of an upper portion of the impact tool according to the embodiment.

FIG. 3 is a plan view of the upper portion of the impact tool according to the embodiment.

FIG. 4 is a front view of the upper portion of the impact tool according to the embodiment.

FIG. 5 is a cross-sectional view of the upper portion of the impact tool according to the embodiment.

FIG. 6 is a cross-sectional view of a tool holder in the embodiment.

FIG. 7 is a cross-sectional view of the tool holder in the embodiment.

FIG. 8 is an enlarged view of a portion in FIG. 6.

FIG. 9 is an enlarged view of a portion in FIG. 7.

FIG. 10 is a cross-sectional view taken along line A-A in FIG. 6 as viewed in the direction indicated by arrows.

FIG. 11 is a perspective view of the tool holder in the embodiment.

FIG. 12 is an exploded perspective view of the tool holder in the embodiment.

FIG. 13 is a front perspective view of balls, buttons, and a locking member in the embodiment, showing their relationship.

FIG. 14 is a rear perspective view of the balls, the buttons, and the locking member in the embodiment, showing their relationship.

FIG. 15 is a rear perspective view of the buttons in the embodiment.

FIG. 16 is a rear perspective view of a support and the buttons in the embodiment, showing their relationship.

### DETAILED DESCRIPTION

### Embodiments

One or more embodiments will now be described with reference to the drawings. In the embodiments, the positional relationships between the components will be described using the directional teens such as right and left (or lateral), front and rear (or forward and backward), and up and down (or vertical). The terms indicate relative positions or directions with respect to the center of an impact tool 1. The impact tool 1 includes a motor 6 as a power supply.

In the embodiments, a direction parallel to a rotation axis AX of the motor 6 is referred to as an axial direction for convenience. A direction about the rotation axis AX is referred to as a circumferential direction or circumferentially, or a rotation direction for convenience. A direction radial from the rotation axis AX is referred to as a radial direction or radially for convenience.

The rotation axis AX extends in a front-rear direction. The axial direction is from the front to the rear or from the rear to the front. A position nearer the rotation axis AX in the radial direction, or a radial direction toward the rotation axis AX, is referred to as radially inside or radially inward for convenience. A position farther from the rotation axis AX in the radial direction, or a radial direction away from the rotation axis AX, is referred to as radially outside or radially outward for convenience.

### Impact Tool

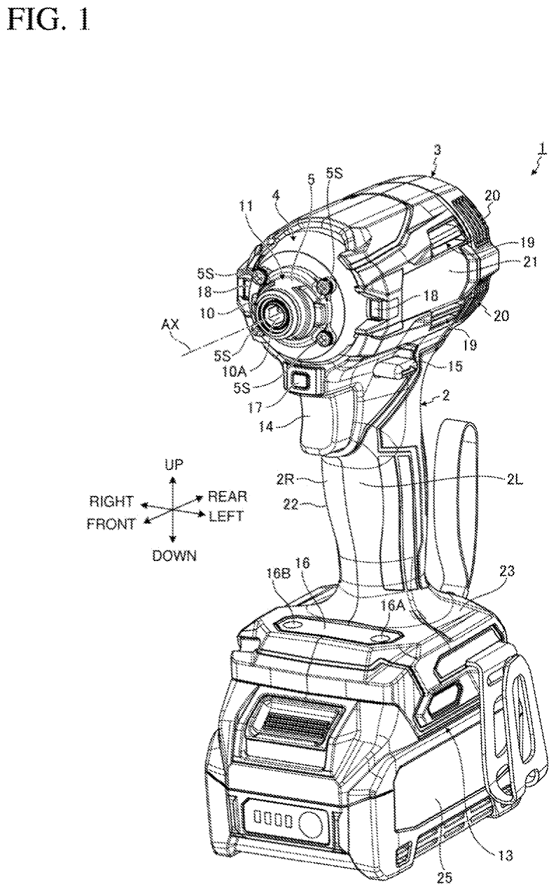

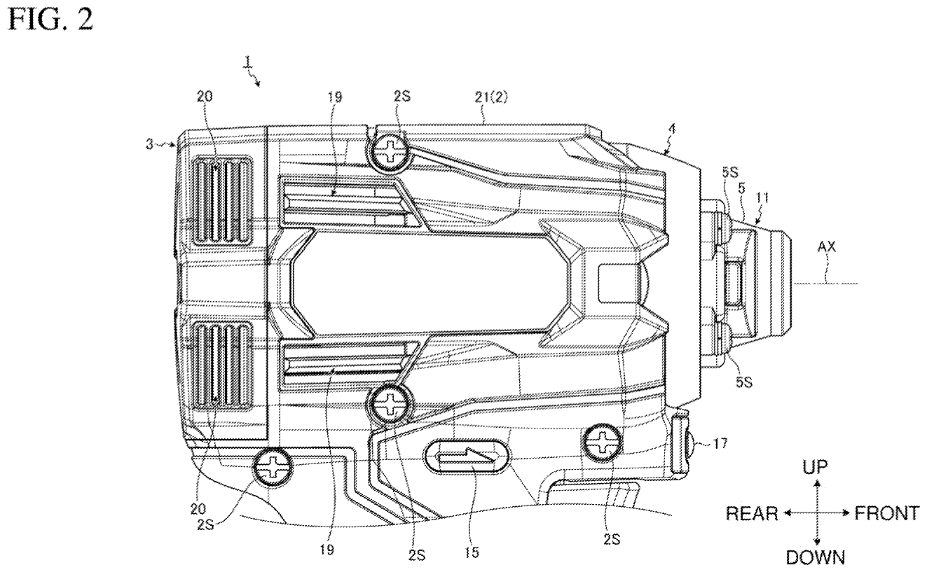

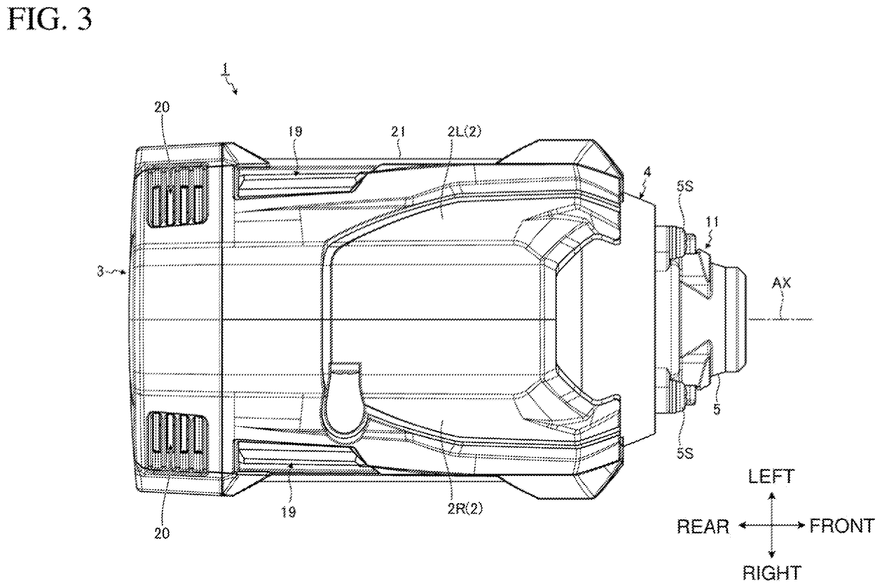

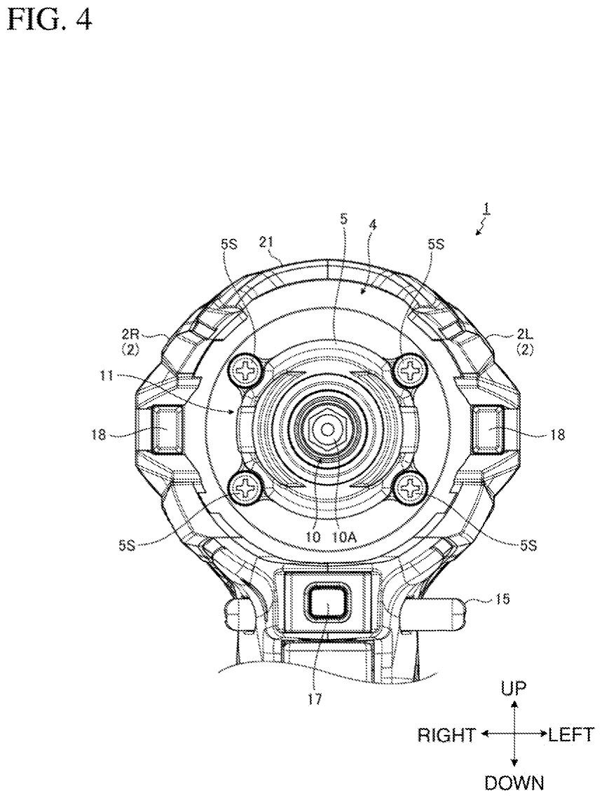

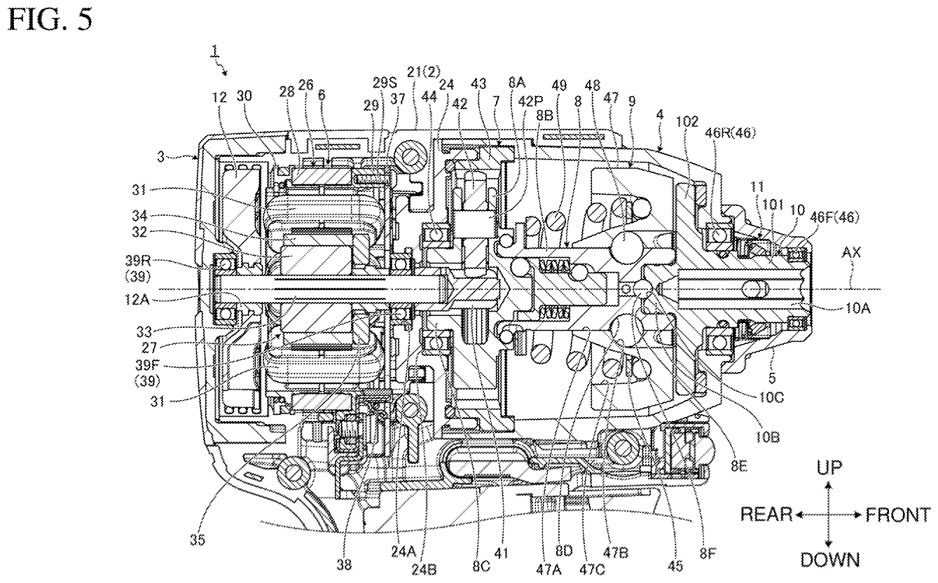

FIG. 1 is a perspective view of the impact tool 1 according to the embodiment. FIG. 2 is a side view of an upper portion of the impact tool 1 according to the embodiment. FIG. 3 is a plan view of the upper portion of the impact tool 1 according to the embodiment. FIG. 4 is a front view of the upper portion of the impact tool 1 according to the embodiment. FIG. 5 is a cross-sectional view of the upper portion of the impact tool 1 according to the embodiment.

The impact tool 1 according to the embodiment is an impact driver that is a screwing machine. The impact tool 1 includes a housing 2, a rear cover 3, a hammer case 4, a support 5, a motor 6, a reducer 7, a spindle 8, a striker 9, an anvil 10, a tool holder 11, a fan 12, a battery mount 13, a trigger switch 14, a forward-reverse switch lever 15, an operation panel 16, a mode switch 17, and lamps 18.

The housing 2 is formed from a synthetic resin. The housing 2 in the embodiment is formed from nylon. The housing 2 includes a left housing 2L and a right housing 2R. The right housing 2R is located on the right of the left housing 2L. The left housing 2L and the right housing 2R are fastened together with multiple screws 2S. The housing 2 includes a pair of housing halves.

The housing 2 includes a motor compartment 21, a grip 22, and a battery connection portion 23.

The motor compartment 21 is cylindrical. The motor compartment 21 accommodates the motor 6. The motor compartment 21 accommodates at least a part of the hammer case 4.

The grip 22 protrudes downward from the motor compartment 21. The trigger switch 14 is located on an upper portion of the grip 22. The grip 22 is grippable by an operator.

The battery connection portion 23 is connected to a lower end of the grip 22. The battery connection portion 23 has larger outer dimensions than the grip 22 in the front-rear and lateral directions.

The rear cover 3 is formed from a synthetic resin. The rear cover 3 is located behind the motor compartment 21. The rear cover 3 accommodates at least a part of the fan 12. The fan 12 is located circumferentially inward from the rear cover 3. The rear cover 3 covers an opening in the rear end of the motor compartment 21.

The motor compartment 21 has inlets 19. The rear cover 3 has outlets 20. Air outside the housing 2 flows into the internal space of the housing 2 through the inlets 19. The air then flows out of the housing 2 through the outlets 20.

The hammer case 4 is formed from metal. The hammer case 4 in the embodiment is formed from aluminum. The hammer case 4 is cylindrical. The hammer case 4 connects to the front portion of the motor compartment 21. A bearing box 24 is fixed to a rear portion of the hammer case 4. The bearing box 24 has a thread on its outer periphery. The hammer case 4 has a threaded groove on its inner periphery. The thread on the bearing box 24 is engaged with the threaded groove on the hammer case 4 to fasten the bearing box 24 and the hammer case 4 together. The hammer case 4 is held between the left housing 2L and the right housing 2R. The hammer case 4 is at least partially accommodated in the motor compartment 21. The bearing box 24 is fixed to the motor compartment 21 and the hammer case 4.

The hammer case 4 accommodates at least parts of the reducer 7, the spindle 8, the striker 9, and the anvil 10. The reducer 7 is located at least partially inside the bearing box 24. The reducer 7 includes multiple gears.

The support 5 is located in front of the hammer case 4. The support 5 surrounds the anvil 10. The support 5 is substantially cylindrical. The support 5 accommodates at least a part of the tool holder 11. The support 5 is fixed to the front of the hammer case 4. The support 5 in the embodiment is fastened to the hammer case 4 with four screws 5S.

The motor 6 is a power source for the impact tool 1. The motor 6 is a brushless inner-rotor motor. The motor 6 includes a stator 26 and a rotor 27. The stator 26 is supported on the motor compartment 21. The rotor 27 is located at least partially inside the stator 26. The rotor 27 rotates relative to the stator 26. The rotor 27 rotates about the rotation axis AX extending in the front-rear direction.

The stator 26 includes a stator core 28, a front insulator 29, a rear insulator 30, and coils 31.

The stator core 28 is located radially outside the rotor 27. The stator core 28 includes multiple steel plates stacked on one another. The steel plates are metal plates formed from iron as a main component. The stator core 28 is cylindrical. The stator core 28 has multiple teeth to support the coils 31.

The front insulator 29 is located on the front of the stator core 28. The rear insulator 30 is located on the rear of the stator core 28. The front insulator 29 and the rear insulator 30 are electrical insulating members formed from a synthetic resin. The front insulator 29 partially covers the surfaces of the teeth. The rear insulator 30 partially covers the surfaces of the teeth.

The coils 31 are attached to the stator core 28 with the front insulator 29 and the rear insulator 30 between them. The stator 26 includes multiple coils 31. The coils 31 surround the teeth in the stator core 28 with the front insulator 29 and the rear insulator 30 in between. The coils 31 and the stator core 28 are electrically insulated from each other with the front insulator 29 and the rear insulator 30. The coils 31 are connected to one another with fuse terminals 38.

The rotor 27 rotates about the rotation axis AX. The rotor 27 includes a rotor core 32, a rotor shaft 33, a rotor magnet 34, and a sensor magnet 35.

The rotor core 32 and the rotor shaft 33 are formed from steel. The rotor shaft 33 has a front portion protruding frontward from the front end face of the rotor core 32. The rotor shaft 33 has a rear portion protruding rearward from the rear end face of the rotor core 32.

The rotor magnet 34 is fixed to the rotor core 32. The rotor magnet 34 is cylindrical. The rotor magnet 34 surrounds the rotor core 32.

The sensor magnet 35 is fixed to the rotor core 32. The sensor magnet 35 is annular. The sensor magnet 35 is located on the front end face of the rotor core 32 and the front end face of the rotor magnet 34.

A sensor board 37 is attached to the front insulator 29. The sensor board 37 is fastened to the front insulator 29 with a screw 29S. The sensor board 37 includes a circuit board and a rotation detector. The circuit board is circular and has a hole at the center. The rotation detector is supported by the circuit board. The sensor board 37 at least partially faces the sensor magnet 35. The rotation detector detects the position of the sensor magnet 35 on the rotor 27 to detect the position of the rotor 27 in the rotation direction.

The rotor shaft 33 is rotatably supported by a rotor bearing 39. The rotor bearing 39 includes a front rotor bearing 39F and a rear rotor bearing 39R. The front rotor bearing 39F rotatably supports the front portion of the rotor shaft 33. The rear rotor bearing 39R rotatably supports the rear portion of the rotor shaft 33.

The front rotor bearing 39F is held by the bearing box 24. The bearing box 24 has a recess 24A. The recess 24A is recessed frontward from the rear surface of the bearing box 24. The front rotor bearing 39F is received in the recess 24A. The rear rotor bearing 39R is held by the rear cover 3. The front end of the rotor shaft 33 is located inside the hammer case 4 through an opening of the bearing box 24.

A pinion gear 41 is located on the front end of the rotor shaft 33. The pinion gear 41 is connected to at least a part of the reducer 7. The rotor shaft 33 is connected to the reducer 7 with the pinion gear 41.

The reducer 7 is located frontward from the motor 6. The reducer 7 connects the rotor shaft 33 and the spindle 8 together. The reducer 7 transmits rotation of the rotor 27 to the spindle 8. The reducer 7 rotates the spindle 8 at a lower rotational speed than the rotor shaft 33. The reducer 7 includes a planetary gear assembly.

The reducer 7 includes multiple gears. The rotor 27 drives the gears in the reducer 7.

The reducer 7 includes multiple planetary gears 42 and an internal gear 43. The multiple planetary gears 42 surround the pinion gear 41. The internal gear 43 surrounds the multiple planetary gears 42. The pinion gear 41, the planetary gears 42, and the internal gear 43 are accommodated in the hammer case 4. Each planetary gear 42 meshes with the pinion gear 41. The planetary gears 42 are rotatably supported by the spindle 8 with a pin 42P. The spindle 8 is rotated by the planetary gears 42. The internal gear 43 includes internal teeth that mesh with the planetary gears 42. The internal gear 43 is fixed to the bearing box 24. The internal gear 43 is constantly nonrotatable relative to the bearing box 24.

When the rotor shaft 33 rotates as driven by the motor 6, the pinion gear 41 rotates, and the planetary gears 42 revolve about the pinion gear 41. The planetary gears 42 meshing with the internal teeth on the internal gear 43 revolve. The revolving planetary gears 42 rotate the spindle 8, connected to the planetary gears 42 with the pin 42P, at a lower rotational speed than the rotor shaft 33.

The spindle 8 is located frontward from at least a part of the motor 6. The spindle 8 is located frontward from the stator 26. The spindle 8 is located at least partially frontward from the rotor 27. The spindle 8 is located at least partially in front of the reducer 7. The spindle 8 is located behind the anvil 10. The spindle 8 is rotated by the rotor 27. The spindle 8 rotates with a rotational force from the rotor 27 transmitted by the reducer 7. The spindle 8 transmits a rotational force from the motor 6 to the anvil 10.

The spindle 8 includes a flange 8A and a spindle shaft 8B. The spindle shaft 8B protrudes frontward from the flange 8A. The planetary gears 42 are rotatably supported by the flange 8A with the pin 42P. The rotation axis of the spindle 8 aligns with the rotation axis AX of the motor 6. The spindle 8 rotates about the rotation axis AX. The spindle 8 is rotatably supported by a spindle bearing 44. The spindle 8 has a protrusion 8C on its rear end. The protrusion 8C protrudes rearward from the flange 8A. The protrusion 8C is located inside the spindle bearing 44. The spindle bearing 44 supports the protrusion 8C.

The bearing box 24 at least partially surrounds the spindle 8. The spindle bearing 44 is held by the bearing box 24. The bearing box 24 has a recess 24B. The recess 24B is recessed rearward from the front surface of the bearing box 24. The spindle bearing 44 is received in the recess 24B.

The striker 9 is driven by the motor 6. A rotational force from the motor 6 is transmitted to the striker 9 through the reducer 7 and the spindle 8. The striker 9 strikes the anvil 10 in the rotation direction in response to the rotational force of the spindle 8 rotated by the motor 6. The striker 9 includes a hammer 47, balls 48, and a coil spring 49. The striker 9 including the hammer 47 is accommodated in the hammer case 4.

The hammer 47 is located frontward from the reducer 7. The hammer 47 surrounds the spindle 8. The hammer 47 is held by the spindle 8. The balls 48 are located between the spindle 8 and the hammer 47. The coil spring 49 is supported by the spindle 8 and the hammer 47.

The hammer 47 is cylindrical. The hammer 47 surrounds the spindle shaft 8B. The hammer 47 has a hole 47A for receiving the spindle shaft 8B.

The hammer 47 is rotated by the motor 6. A rotational force from the motor 6 is transmitted to the hammer 47 through the reducer 7 and the spindle 8. The hammer 47 is rotatable together with the spindle 8 in response to the rotational force of the spindle 8 rotated by the motor 6. The rotation axis of the hammer 47 and the rotation axis of the spindle 8 align with the rotation axis AX of the motor 6. The hammer 47 rotates about the rotation axis AX.

The balls 48 are formed from metal such as steel. The balls 48 are located between the spindle shaft 8B and the hammer 47. The spindle 8 has a spindle groove 8D. The spindle groove 8D receives at least parts of the balls 48. The spindle groove 8D is on the outer surface of the spindle shaft 8B. The hammer 47 has a hammer groove 47B. The hammer groove 47B receives at least parts of the balls 48. The hammer groove 47B is on the inner surface of the hammer 47. The balls 48 are located between the spindle groove 8D and the hammer groove 47B. The balls 48 roll along the spindle groove 8D and the hammer groove 47B. The hammer 47 is movable together with the balls 48. The spindle 8 and the hammer 47 are movable relative to each other in the axial and rotation directions within a movable range defined by the spindle groove 8D and the hammer groove 47B.

The coil spring 49 generates an elastic force for moving the hammer 47 forward. The coil spring 49 is located between the flange 8A and the hammer 47. An annular recess 47C is located on a rear surface of the hammer 47. The recess 47C is recessed frontward from the rear surface of the hammer 47. A washer 45 is received in the recess 47C. The rear end of the coil spring 49 is supported by the flange 8A. The front end of the coil spring 49 is received in the recess 47C and supported by the washer 45.

The anvil 10 is located at least partially frontward from the hammer 47. The anvil 10 has a tool hole 10A in the front end of the anvil 10. The tool hole 10A receives a tip tool. The tip tool is attached to the anvil 10.

The anvil 10 includes an anvil protrusion 10B on the rear end of the anvil 10. The anvil protrusion 10B protrudes rearward from the rear end of the anvil 10. The spindle 8 is located behind the anvil 10. A spindle recess 8E is located on the front end of the spindle shaft 8B. The spindle recess 8E receives the anvil protrusion 10B. A ball 8F is located in the spindle recess 8E. The anvil protrusion 10B has a contact surface 10C spherical and in contact with the surface of the ball 8F.

The anvil 10 includes a rod-like anvil body 101 and an anvil projection 102. The tool hole 10A is located in the front end of the anvil body 101. The tip tool is attached to the anvil body 101. The anvil projection 102 is located on the rear end of the anvil 10. The anvil projection 102 protrudes radially outward from the rear end of the anvil body 101.

The anvil 10 is rotatably supported by an anvil bearing 46. The rotation axis of the anvil 10 aligns with the rotation axis of the hammer 47, the rotation axis of the spindle 8, and the rotation axis AX of the motor 6. The anvil 10 rotates about the rotation axis AX. The anvil bearing 46 is held by the hammer case 4. The anvil bearing 46 in the embodiment includes a front anvil bearing 46F and a rear anvil bearing 46R. The front anvil bearing 46F supports a front portion of the anvil 10. The rear anvil bearing 46R supports a rear portion of the anvil 10. The front anvil bearing 46F rotatably supports the front portion of the anvil body 101. The rear anvil bearing 46R rotatably supports the rear portion of the anvil body 101. The front anvil bearing 46F is press-fitted to the front end of the anvil 10 from the front. The front anvil bearing 46F is supported by the support 5. The rear anvil bearing 46R is supported by the hammer case 4.

The hammer 47 can at least partially come in contact with the anvil projection 102. The hammer 47 has, at its front, hammer projections protruding frontward. The hammer projections on the hammer 47 and the anvil projection 102 can come in contact with each other. The motor 6 operates in this state to cause the anvil 10 to rotate together with the hammer 47 and the spindle 8.

The anvil 10 is struck by the hammer 47 in the rotation direction. When, for example, the anvil 10 receives a higher load in a screwing operation, the anvil 10 may fail to rotate with power generated by the motor 6 alone. This stops rotation of the anvil 10 and the hammer 47. The spindle 8 and the hammer 47 are movable relative to each other in the axial and circumferential directions with the balls 48 in between. Although the hammer 47 stops rotating, the spindle 8 continues to rotate with power generated by the motor 6. When the hammer 47 stops rotating and the spindle 8 continues to rotate, the balls 48 move backward as being guided along the spindle groove 8D and the hammer groove 47B. The hammer 47 receives a force from the balls 48 to move backward with the balls 48. In other words, the hammer 47 moves backward when the anvil 10 stops rotating and the spindle 8 rotates. Thus, the hammer 47 and the anvil projection 102 are out of contact from each other.

The coil spring 49 generates an elastic force for moving the hammer 47 forward. The hammer 47 that has moved rearward then moves forward under the elastic force from the coil spring 49. When moving forward, the hammer 47 receives a force in the rotation direction from the balls 48. In other words, the hammer 47 moves forward while rotating. The hammer 47 then comes in contact with the anvil projection 102 while rotating. Thus, the anvil projection 102 is struck by the hammer 47 in the rotation direction. The anvil 10 receives power from the motor 6 and the inertial force from the hammer 47. The anvil 10 thus rotates with high torque about the rotation axis AX.

The tool holder 11 surrounds a front portion of the anvil 10. The tool holder 11 holds a tip tool received in the tool hole 10A. The tool holder 11 is at least partially accommodated in the support 5.

The fan 12 is located rearward from the stator 26 in the motor 6. The fan 12 generates an airflow for cooling the motor 6. The fan 12 is fastened to at least a part of the rotor 27, or specifically, to a rear portion of the rotor shaft 33 with a bush 12A. The fan 12 is located between the rear rotor bearing 39R and the stator 26. The fan 12 rotates as the rotor 27 rotates. As the rotor shaft 33 rotates, the fan 12 rotates together with the rotor shaft 33. Air outside the housing 2 flows into the internal space of the housing 2 through the inlets 19 and flows through the internal space of the housing 2, cooling the motor 6. As the fan 12 rotates, the air passing through the housing 2 flows out of the housing 2 through the outlets 20.

The battery mount 13 is located below the battery connection portion 23. The battery mount 13 is connected to a battery pack 25. The battery pack 25 is attached to the battery mount 13. The battery pack 25 is detachable from the battery mount 13. The battery pack 25 includes a secondary battery. The battery pack 25 in the embodiment includes a rechargeable lithium-ion battery. The battery pack 25 is attached to the battery mount 13 to power the impact tool 1. The motor 6 is driven by power supplied from the battery pack 25.

The trigger switch 14 is located on the grip 22. The trigger switch 14 is operable by the operator to activate the motor 6. The trigger switch 14 is operable to switch the motor 6 between the driving state and the stopped state.

The forward-reverse switch lever 15 is located above the grip 22. The forward-reverse switch lever 15 is operable by the operator. The forward-reverse switch lever 15 is operable to switch the rotation direction of the motor 6 between forward and reverse. This operation switches the rotation direction of the spindle 8.

The operation panel 16 is located on the battery connection portion 23. The operation panel 16 is operable by the operator to switch the control mode of the motor 6. The operation panel 16 includes an impact switch 16A and a specific switch 16B. The impact switch 16A and the specific switch 16B are operable by the operator. At least either the impact switch 16A or the specific switch 16B is operated to switch the control mode of the motor 6.

The mode switch 17 is located above the trigger switch 14. The mode switch 17 is operable by the operator. The mode switch 17 is operable to switch the control mode of the motor 6.

The lamps 18 emit illumination light. The lamps 18 illuminate the anvil 10 and an area around the anvil 10 with illumination light. The lamps 18 illuminate an area ahead of the anvil 10 with illumination light. The lamps 18 also illuminate a tip tool attached to the anvil 10 and an area around the tip tool with illumination light. The lamps 18 in the embodiment are located on the left and right of the hammer case 4.

### Tool Holder

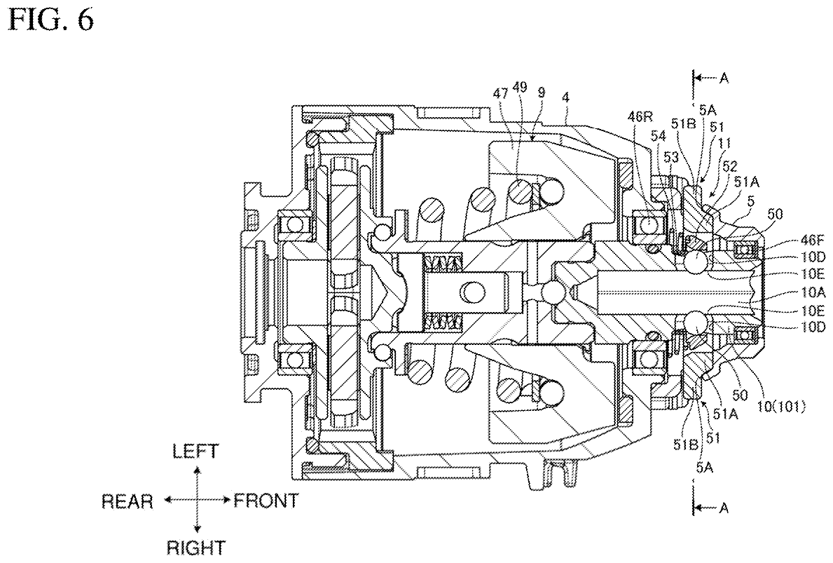

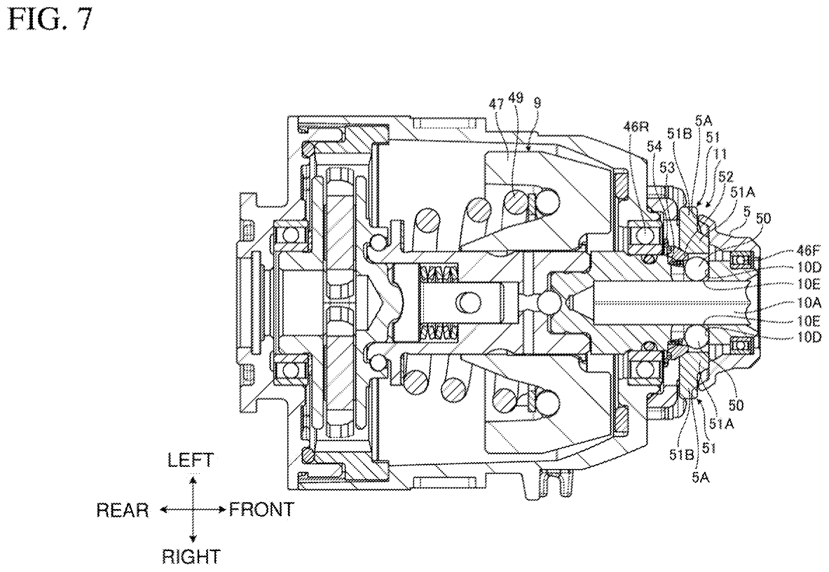

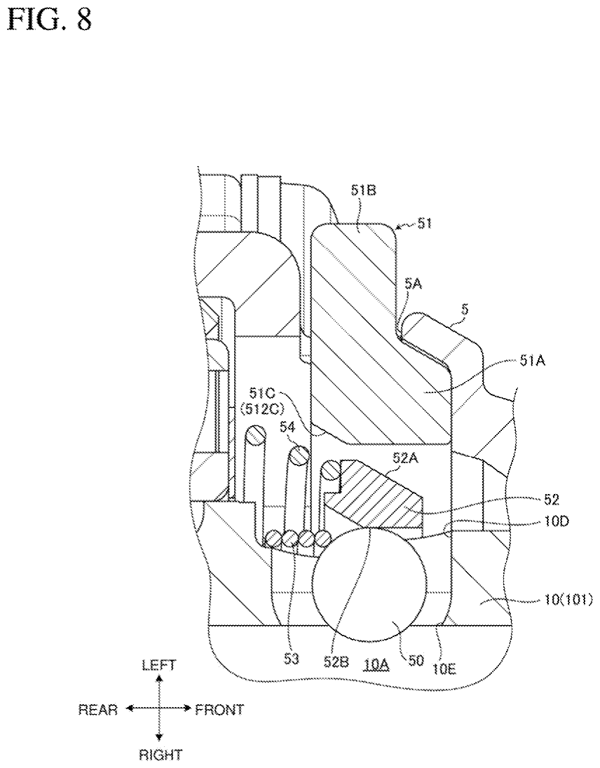

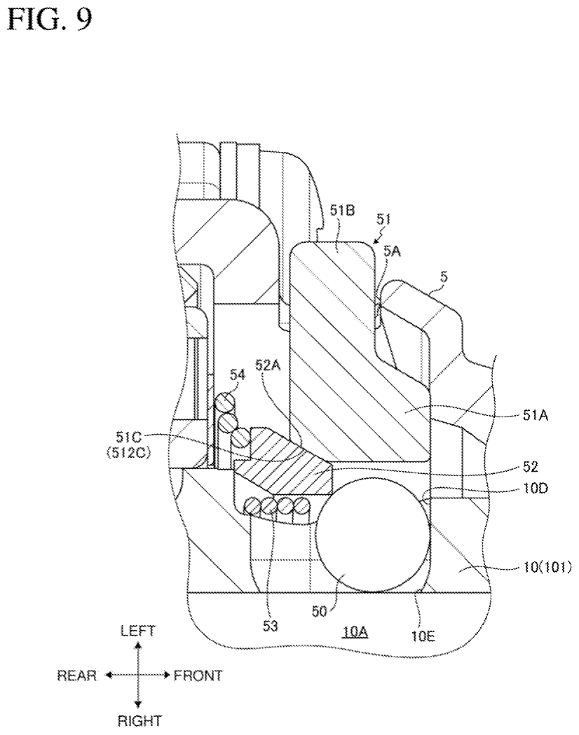

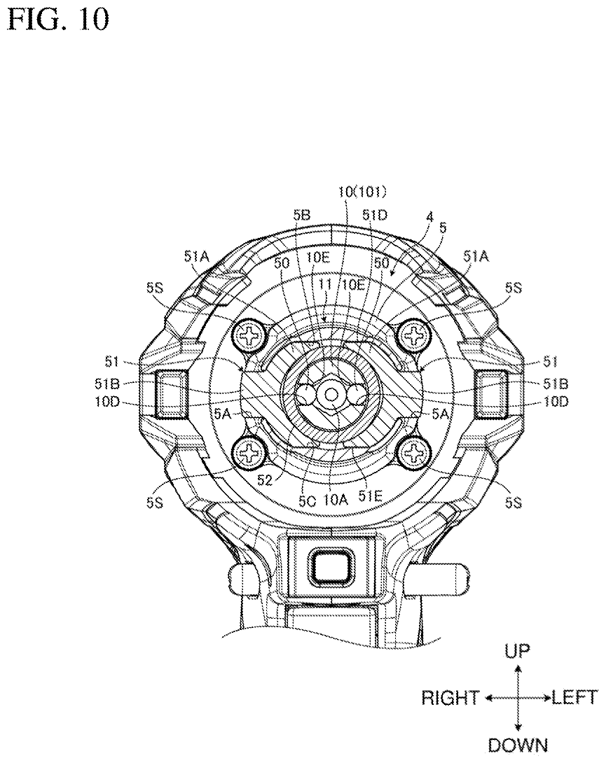

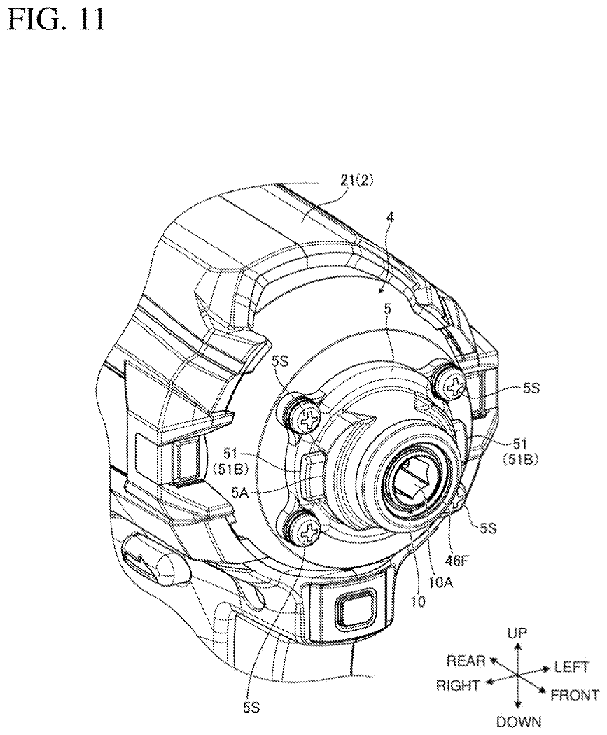

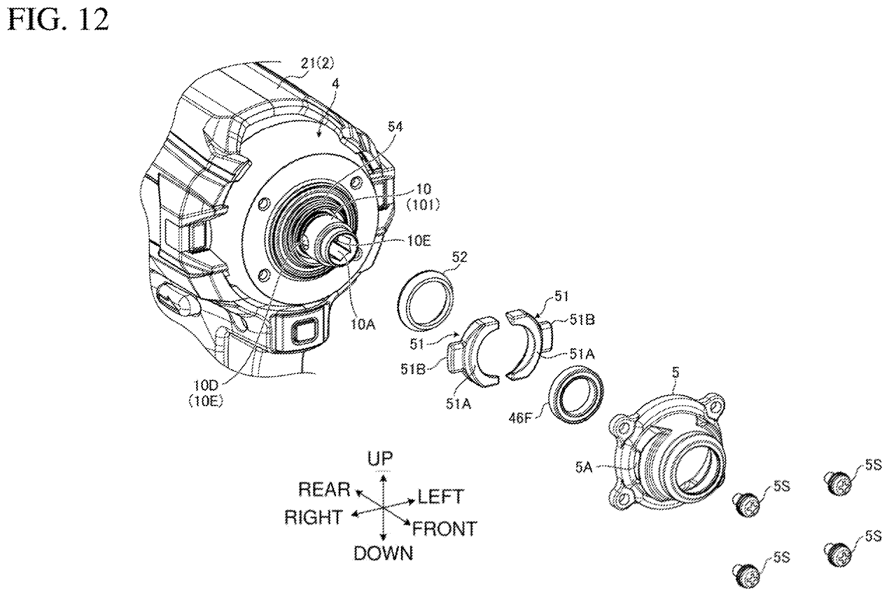

FIGS. 6 and 7 each are a cross-sectional view of the tool holder 11 in the present embodiment. FIG. 8 is an enlarged view of a portion in FIG. 6. FIG. 9 is an enlarged view of a portion in FIG. 7. FIG. 10 is a cross-sectional view taken along line A-A in FIG. 6 as viewed in the direction indicated by arrows. FIG. 11 is a perspective view of the tool holder 11 in the embodiment. FIG. 12 is an exploded perspective view of the tool holder 11 in the embodiment.

The tool holder 11 surrounds the anvil body 101. The tool holder 11 holds a tip tool received in the tool hole 10A. The tool hole 10A extends rearward from the front end of the anvil body 101. The tool hole 10A is hexagonal in a cross section orthogonal to the rotation axis AX.

The anvil body 101 has two recesses 10D on its outer surface. The recesses 10D are recessed radially inward from the outer surface of the anvil body 101. The recesses 10D are elongated in the axial direction. Ball holes 10E are located inward from the recesses 10D. The ball holes 10E connect to the tool hole 10A.

The tool holder 11 includes two balls 50, buttons 51, a locking member 52, a ball urging member 53, and a locking urging member 54.

The balls 50 are received in the recesses 10D. The balls 50 are formed from metal. A single ball 50 is received in a single recess 10D. The ball 50 is movable in the radial and axial directions. The ball 50 is supported in the recess 10D in a movable manner. The outer diameter of the ball 50 is larger than the inner diameter of the ball hole 10E. The ball 50 at least partially enters the tool hole 10A through the ball hole 10E in the anvil 10. The ball 50 moves radially inward to be at least partially in the tool hole 10A through the ball hole 10E. The ball 50 retracts from the tool hole 10A. The ball 50 moves radially outward to be outside the tool hole 10A.

A position at which the ball 50 is at least partially in the tool hole 10A through the ball hole 10E will be hereafter referred to as an entered position as appropriate. A position at which the ball 50 is outside the tool hole 10A will be referred to as a retracted position as appropriate. The entered position is radially inward from the retracted position. The ball 50 is movable between the entered position and the retracted position.

The buttons 51 are moved radially to move the balls 50. The tool holder 11 includes two buttons 51. The buttons 51 are located on the left and right of the rotation axis AX. The buttons 51 are laterally movable.

The support 5 supports the buttons 51 in a movable manner. Each button 51 includes an arc portion 51A and an operation portion 51B. The arc portion 51A is located inside the support 5. The operation portion 51B protrudes radially outward from the arc portion 51A. The operation portion 51B is located at least partially outside the support 5. The support 5 has openings 5A. The openings 5A extend through the inner and outer surfaces of the support 5. The openings 5A are located on the left and right of the rotation axis AX. The operation portion 51B is partially in the opening 5A.

In response to an operation performed by the operator, the buttons 51 move radially inward to move the balls 50 from the entered position to the retracted position.

The support 5 is formed from metal. Examples of the material for the support 5 include aluminum. The buttons 51 are formed from a synthetic resin. The buttons 51 are formed from a material with a low coefficient of friction with the support 5. Examples of the material for the buttons 51 include polytetrafluoroethylene (PTFE) and polyoxymethylene (POM). The buttons 51 with a low coefficient of friction with the support 5 can be moved smoothly by the operator.

The locking member 52 surrounds the anvil body 101 in the anvil 10. The locking member 52 is formed from metal. The locking member 52 is annular. The locking member 52 is movable in the front-rear direction while being guided by the anvil body 101.

The locking member 52 is located radially outward from the balls 50. The locking member 52 is in contact with the balls 50. The locking member 52 is movable between a lock position and a release position. At the lock position, the locking member 52 presses the balls 50 to the entered position. At the release position, the locking member 52 stops pressing on the balls 50.

In response to the buttons 51 being operated, the locking member 52 moves in the axial direction. The two buttons 51 are operated to allow the locking member 52 to move stably in the axial direction. The locking member 52 moves while being in contact with the buttons 51. The buttons 51 are formed from a material with a low coefficient of friction with the locking member 52. As described above, examples of the material for the buttons 51 include PTFE and POM. The buttons 51 with a low coefficient of friction with the locking member 52 can slide on the locking member 52 smoothly.

The buttons 51 are located radially outward from the locking member 52. The buttons 51 are in contact with the locking member 52. The buttons 51 move radially to move the locking member 52 between the lock position and the release position.

FIGS. 6 and 8 show the locking member 52 at the lock position. FIGS. 7 and 9 show the locking member 52 at the release position. The buttons 51 move radially inward to move the locking member 52 from the lock position to the release position. The buttons 51 move radially outward to move the locking member 52 from the release position to the lock position. The lock position is frontward from the release position. The buttons 51 move radially inward to move the locking member 52 backward to the release position.

As shown in FIG. 8, the locking member 52 at the lock position is located radially outside the balls 50 with an inner surface 52B of the locking member 52 being in contact with the surface of each ball 50. The locking member 52 located radially outside the balls 50 prevents the balls 50 from moving from the entered position to the retracted position. In other words, the balls 50 cannot move radially outward.

As shown in FIG. 9, the locking member 52 at the release position does not align with the balls 50 in the axial direction. A space is thus left in front of the locking member 52 for at least a part of each ball 50 to enter. The balls 50 can thus move radially outward. The balls 50 can move from the entered position to the retracted position. Upon coming in contact with the tip tool received in the tool hole 10A, the balls 50 receive an external force from the tip tool. The locking member 52 at the release position allows the balls 50 to move radially outward. The buttons 51 are located radially outside the balls 50 at the retracted position. The buttons 51 restrict the balls 50 from moving excessively radially outward.

The ball urging member 53 urges the balls 50 to move from the retracted position to the entered position. In other words, the ball urging member 53 urges the balls 50 to move radially inward. The ball urging member 53 in the embodiment is a coil spring surrounding the recesses 10D. The ball urging member 53 comes in contact with the balls 50.

Upon coming in contact with the tip tool received in the tool hole 10A, the balls 50 receive an external force from the tip tool and move radially outward. The balls 50 moving radially outward increase the diameter of the ball urging member 53. The balls 50 released from the external force from the tip tool move radially inward under an urging force from the ball urging member 53.

The locking urging member 54 urges the locking member 52 to move from the release position to the lock position. In other words, the locking urging member 54 applies an urging force to the locking member 52 to move the locking member 52 forward. The locking urging member 54 in the embodiment is, for example, a conical spring or a coil spring located behind the locking member 52. The locking urging member 54 surrounds the anvil body 101. The rear end of the locking urging member 54 is in contact with, for example, a flat washer located at the front of the rear anvil bearing 46R. The front end of the locking urging member 54 is in contact with the rear surface of the locking member 52.

The buttons 51 in the embodiment are operated by the operator to move radially inward. The buttons 51 move radially outward under an urging force from the locking urging member 54. The locking member 52 in contact with the buttons 51 is urged frontward by the locking urging member 54. This causes the buttons 51 to move radially outward.

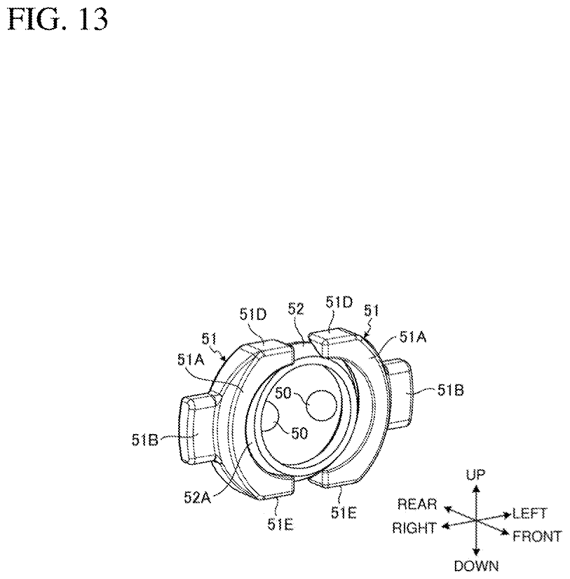

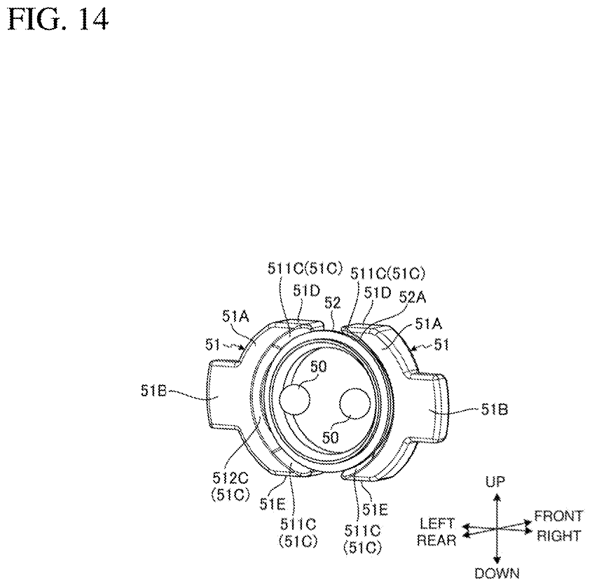

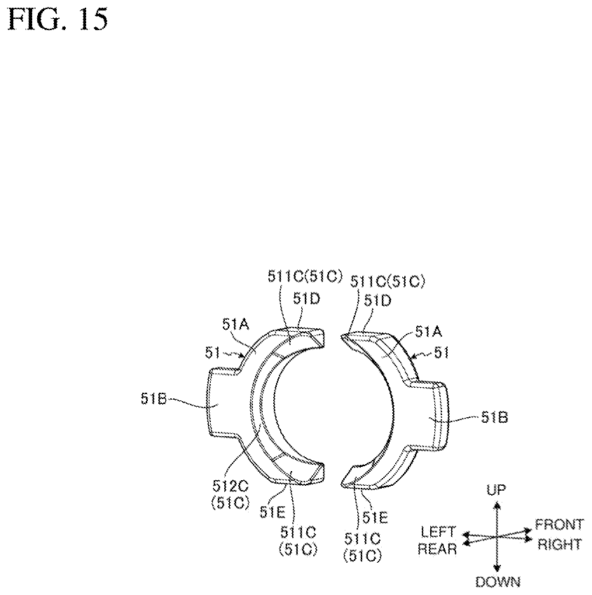

FIG. 13 is a front perspective view of the balls 50, the buttons 51, and the locking member 52 in the embodiment, showing their relationship. FIG. 14 is a rear perspective view of the balls 50, the buttons 51, and the locking member 52 in the embodiment, showing their relationship. FIG. 15 is a rear perspective view of the buttons 51 in the embodiment.

The locking member 52 is located radially outward from the balls 50. The buttons 51 are located radially outward from the locking member 52. Each button 51 includes the arc portion 51A. The arc portion 51A at least partially surrounds the locking member 52. The locking member 52 is surrounded by the two arc portions 51A.

Each button 51 has a pressing surface 51C. The pressing surface 51C is inclined radially outward. The pressing surface 51C is in contact with at least a part of the locking member 52. The locking member 52 has a slide surface 52A. The slide surface 52A is inclined radially outward. The slide surface 52A is in contact with at least a part of the pressing surface 51C.

The pressing surface 51C in the embodiment includes first pressing portions 511C and a second pressing portion 512C. With the locking member 52 at the lock position, the first pressing portions 511C are in contact with a part of the slide surface 52A. With the locking member 52 at the release position, the second pressing portion 512C is in contact with another part of the slide surface 52A. The first pressing portions 511C are defined in upper and lower areas of the pressing surface 51C. The second pressing portion 512C is defined between the two first pressing portions 511C in the vertical direction. The first pressing portions 511C and the second pressing portion 512C are arc-shaped surfaces. The first pressing portions 511C and the second pressing portion 512C are oriented in different directions.

FIGS. 13 and 14 show the locking member 52 at the lock position. With the locking member 52 at the lock position, the first pressing portions 511C are in contact with a part of the slide surface 52A, and the second pressing portion 512C is apart from the slide surface 52A. With the locking member 52 at the release position, the second pressing portion 512C is in contact with a part of the slide surface 52A, and the first pressing portions 511C are apart from the slide surface 52A.

As shown in FIG. 8, when the buttons 51 are located radially outward, the second pressing portion 512C of the pressing surface 51C is apart from the slide surface 52A. As shown in FIG. 9, when the buttons 51 move radially inward, the second pressing portion 512C in the pressing surface 51C comes in contact with the slide surface 52A. In response to the buttons 51 moving further radially inward, the locking member 52 moves backward while being guided by the anvil body 101 as shown in FIG. 9. This causes the locking member 52 to move from the lock position to the release position.

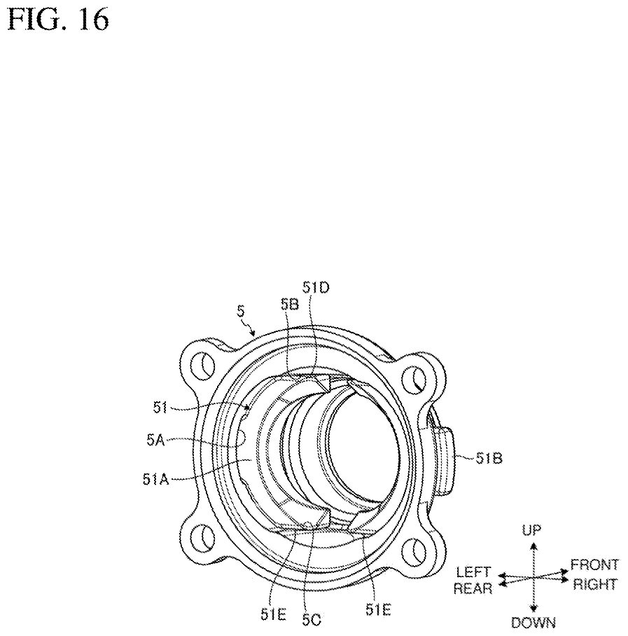

FIG. 16 is a rear perspective view of the support 5 and the buttons 51 in the embodiment, showing their relationship. The arc portion 51A of each button 51 includes an upper surface 51D and a lower surface 51E. As shown in FIGS. 16 and 10, the support 5 includes a guide surface 5B and a guide surface 5C. The guide surface 5B faces the upper surface 51D. The guide surface 5C faces the lower surface 51E. The buttons 51 move laterally while being guided by the guide surface 5B and the guide surface 5C.

### Operation of Tool Holder

The operation of the tool holder 11 will now be described. The operation for placing a tip tool into the tool hole 10A will be described first. A tip tool is placed into the tool hole 10A without the button 51 being operated. The tip tool has a ball groove to receive the balls 50.

Before the tip tool is placed into the tool hole 10A, the balls 50 are at the entered position and the locking member 52 is at the lock position.

The tip tool placed in the tool hole 10A comes in contact with the balls 50 at the entered position. The balls 50 receive an external force from the tip tool and move backward relative to the locking member 52. When receiving an external force from the tip tool further, the balls 50 move radially outward while being in contact with the ball urging member 53. In other words, the tip tool being placed into the tool hole 10A causes the balls 50 to move from the entered position to the retracted position (first retracted position). The balls 50 moving radially outward increase the diameter of the ball urging member 53. When the tip tool is placed further into the tool hole 10A, the balls 50 align with the ball groove on the tip tool. The balls 50 move radially inward under an urging force from the ball urging member 53 to be received in the ball groove on the tip tool. This fixes the tip tool in the tool hole 10A.

The operation for removing the tip tool from the tool hole 10A will now be described. With the tip tool placed in the tool hole 10A, the balls 50 are at the entered position and received in the ball groove on the tip tool and the locking member 52 is at the lock position.

The operator presses the operation portions 51B to move the buttons 51 radially inward. The operator holds the two operation portions 51B between, for example, fingers to simultaneously move the two buttons 51 radially inward. The second pressing portion 512C of the pressing surface 51C of each button 51 then comes in contact with the slide surface 52A of the locking member 52. When the buttons 51 further move radially inward, the locking member 52 moves backward. In other words, the locking member 52 moves from the lock position to the release position. This allows the balls 50 to be movable radially outward. In this state, when the operator pulls the tip tool, the balls 50 receive an external force from the tip tool to move radially outward. This causes the balls 50 to move from the entered position to the retracted position (second retracted position). The tip tool is thus removed from the tool hole 10A without being obstructed by the balls 50.

The retracted position (first retracted position) of the balls 50 for the tip tool being placed into the tool hole 10A is different from the retracted position (second retracted position) of the balls 50 for the tip tool being removed from the tool hole 10A.

### Operation of Impact Tool

The operation of the impact tool 1 will now be described. To perform, for example, a screwing operation on a workpiece, a tip tool (screwdriver bit) for the screwing operation is placed into the tool hole 10A in the anvil 10. The tip tool in the tool hole 10A is held by the tool holder 11. After the tip tool is attached to the anvil 10, the operator grips the grip 22 and operates the trigger switch 14. Power is then supplied from the battery pack 25 to the motor 6 to activate the motor 6 and turn on the lamps 18 at the same time. As the motor 6 is activated, the rotor shaft 33 in the rotor 27 rotates. The rotational force of the rotor shaft 33 is then transmitted to the planetary gears 42 through the pinion gear 41. The planetary gears 42 meshing with the internal teeth on the internal gear 43 revolve about the pinion gear 41 while rotating. The planetary gears 42 are rotatably supported by the spindle 8 with the pin 42P. The revolving planetary gears 42 rotate the spindle 8 at a lower rotational speed than the rotor shaft 33.

When the spindle 8 rotates with the hammer 47 and the anvil projection 102 in contact with each other, the anvil 10 rotates together with the hammer 47 and the spindle 8. The screwing operation proceeds in this manner.

When the anvil 10 receives a predetermined or higher load as the screwing operation proceeds, the anvil 10 and the hammer 47 stop rotating. When the spindle 8 rotates in this state, the hammer 47 moves backward. Thus, the hammer 47 and the anvil projection 102 are out of contact from each other. The hammer 47 that has moved backward moves forward while rotating under an elastic force from the coil spring 49. The anvil 10 is struck by the hammer 47 in the rotation direction. The anvil 10 rotates about the rotation axis AX with high torque. The screw is tightened on the workpiece with high torque.

The impact tool 1 according to the embodiment includes the motor 6, the hammer 47 rotatable by the motor 6, the tool hole 10A for receiving a tip tool, and the anvil 10, which is strikable by the hammer 47 in the rotation direction. The impact tool 1 includes the balls 50 and at least one button 51. Each ball 50 is movable, through the ball hole 10E in the anvil 10, between the entered position at which the ball 50 is at least partially inside the tool hole 10A and the retracted position at which the ball 50 is outside the tool hole 10A. The button 51 is operable to move the balls 50 radially.

This structure has a smaller diameter in the front end of the anvil 10. A tip tool can be attached and detached by moving the button 51 radially. The tip tool can thus be attached and detached with a small movement. The tool holder 11 is also downsized.

The balls 50 move from the entered position to the retracted position in response to the button 51 being moved radially inward.

The button 51 is laterally movable. This improves the operability of the button 51.

The impact tool 1 includes two buttons 51. In response to the two buttons 51 being operated to move nearer each other, the balls 50 move from the entered position to the retracted position.

The balls 50 move from the entered position to the retracted position in response to the tip tool being placed into the tool hole 10A. The tip tool is thus smoothly placed into the tool hole 10A.

The balls 50 are radially movable. The entered position is radially inward from the retracted position. The balls 50 at the entered position allow the tip tool to be held in the anvil 10.

The impact tool 1 includes the ball urging member 53 that urges the balls 50 to move from the retracted position to the entered position. The balls 50 thus move to lock the tip tool.

The impact tool 1 includes the locking member 52 movable between the lock position at which the locking member 52 presses the balls 50 to the entered position and the release position at which the locking member 52 stops pressing. The locking member 52 moves in response to the buttons 51 moving radially. The balls 50 are thus moved through the locking member 52.

The locking member 52 moves from the lock position to the release position in response to the buttons 51 moving radially. This causes the ball 50 to move from the entered position to the retracted position.

The locking member 52 is movable in the front-rear direction. The lock position is frontward from the release position. Thus, the locking member 52 moves backward to the release position.

The buttons 51 are located radially outward from the locking member 52. Each button 51 has the pressing surface 51C inclined radially outward toward the rear to come in contact with at least a part of the locking member 52. The locking member 52 has the slide surface 52A inclined radially outward toward the rear to come in contact with the pressing surface 51C. The button 51 moves with the pressing surface 51C being in contact with the slide surface 52A. This causes the locking member 52 to move to the release position.

The pressing surface 51C includes the first pressing portions 511C and the second pressing portion 512C. The first pressing portions 511C come in contact with a part of the slide surface 52A with the locking member 52 at the lock position. The second pressing portion 512C comes in contact with another part of the slide surface 52A with the locking member 52 at the release position. This improves the operability of the buttons 51.

The impact tool 1 includes the locking urging member 54 that urges the locking member 52 to move from the release position to the lock position. This structure causes, in response to a release operation on the buttons 51, the locking member 52 to move from the release position to the lock position.

The buttons 51 move radially outward in response to the locking member 52 in contact with the buttons 51 being urged by the locking urging member 54. Thus, in response to a release operation on the buttons 51, the buttons 51 move radially outward.

The locking member 52 surrounds the anvil 10. This downsizes the tool holder 11.

The impact tool 1 includes the support 5 surrounding the anvil 10 and supporting the buttons 51 in a movable manner. The support 5 thus supports the tool holder 11.

The impact tool 1 includes the front anvil bearing 46F supporting the front portion of the anvil 10. The front anvil bearing 46F is supported by the support 5. The front end of the anvil 10 has a smaller diameter, thus allowing the front anvil bearing 46F to have a smaller diameter.

The front anvil bearing 46F is press-fitted to the front end of the anvil 10. This increases the strength of the anvil 10. When, for example, the anvil 10 receives a force, from the tip tool, that may deform the anvil 10 to increase the diameter of the anvil 10 in a screwing operation, the front anvil bearing 46F press-fitted to the anvil 10 reduces such deformation of the anvil 10.

The impact tool 1 includes the hammer case 4 accommodating the hammer 47. The support 5 is fixed to the hammer case 4. This reduces the change in the relative positions between the support 5 and the hammer case 4.

The impact tool 1 includes the rear anvil bearing 46R supporting the rear portion of the anvil 10. The rear anvil bearing 46R is supported by the hammer case 4. The anvil 10 is rotatably supported by the rear anvil bearing 46R supported by the hammer case 4.

The impact tool 1 includes the spindle 8 located behind the anvil 10 to transmit a rotational force from the motor 6 to the anvil 10. The anvil protrusion 10B protrudes rearward from the rear end of the anvil 10. The spindle 8 has, at its front end, the spindle recess 8E to receive the anvil protrusion 10B. This structure downsizes the impact tool 1 in the axial direction.

The impact tool 1 according to the embodiment is an impact driver. The impact tool 1 may be an impact wrench.

### Modifications

The impact tool 1 may use utility power (alternating-current power supply) as its power supply instead of the battery pack 25.

### REFERENCE SIGNS LIST

1 impact tool
2 housing
2L left housing
2R right housing
2S screw
3 rear cover
4 hammer case
5 support
5A opening
5B guide surface
5C guide surface
5S screw
6 motor
7 reducer
8 spindle
8A flange
8B spindle shaft
8C protrusion
8D spindle groove
8E spindle recess
8F ball
9 striker
10 anvil
10A tool hole
10B anvil protrusion
10C contact surface
10D recess
10E ball hole
11 tool holder
12 fan
12A bush
13 battery mount
14 trigger switch
15 forward-reverse switch lever
16 operation panel
16A impact switch
16B specific switch
17 mode switch
18 lamp
19 inlet
20 outlet
21 motor compartment
22 grip
23 battery connection portion
24 bearing box
24A recess
24B recess
25 battery pack
26 stator
27 rotor
28 stator core
29 front insulator
29S screw
30 rear insulator
31 coil
32 rotor core
33 rotor shaft
34 rotor magnet
35 sensor magnet
37 sensor board
38 fuse terminal
39 rotor bearing
39F front rotor bearing
39R rear rotor bearing
41 pinion gear
42 planetary gear
42P pin
43 internal gear
44 spindle bearing
45 washer
46 anvil bearing
46F front anvil bearing
46R rear anvil bearing
47 hammer
47A hole
47B hammer groove
47C recess
48 ball
49 coil spring
50 ball
51 button
51A arc portion
51B operation portion
51C pressing surface
511C first pressing portion
512C second pressing portion
51D upper surface
51E lower surface
52 locking member
52A slide surface
52B inner surface
53 ball urging member
54 locking urging member
101 anvil body
102 anvil projection
AX rotation axis

What is claimed is:

1. An impact tool, comprising:
a motor;
a hammer rotatable by the motor;
an anvil having a tool hole to receive a tip tool, the anvil being strikable by the hammer in a rotation direction and having a ball hole;
a ball movable, through the ball hole, between an entered position at which the ball is at least partially inside the tool hole and a retracted position at which the ball is outside the tool hole; and
at least one button operable to move the ball radially.

2. The impact tool according to claim 1, wherein
the ball moves from the entered position to the retracted position in response to the at least one button being moved radially inward.

3. The impact tool according to claim 1, wherein
the at least one button is laterally movable.

4. The impact tool according to claim 1, wherein
the at least one button includes two buttons.

5. The impact tool according to claim 1, wherein
the ball moves from the entered position to the retracted position in response to the tip tool being placed into the tool hole.

6. The impact tool according to claim 5, wherein
the ball is radially movable, and
the entered position is radially inward from the retracted position.

7. The impact tool according to claim 6, further comprising:
a ball urging member configured to urge the ball to move from the retracted position to the entered position.

8. The impact tool according to claim 1, further comprising:
a locking member movable between a lock position at which the locking member presses the ball to the entered position and a release position at which the locking member stops pressing,
wherein the locking member moves in response to the at least one button moving radially.

9. The impact tool according to claim 8, wherein
the locking member moves from the lock position to the release position in response to the at least one button moving radially inward.

10. The impact tool according to claim 9, wherein
the locking member is movable in a front-rear direction, and
the lock position is frontward from the release position.

11. The impact tool according to claim 10, wherein
the at least one button is located radially outward from the locking member,
the at least one button has a pressing surface inclined radially outward rearward to come in contact with at least a part of the locking member,
the locking member has a slide surface inclined radially outward rearward to come in contact with the pressing surface, and
the at least one button moves with the pressing surface being in contact with the slide surface.

12. The impact tool according to claim 11, wherein
the pressing surface includes
a first pressing portion to come in contact with a part of the slide surface with the locking member at the lock position, and
a second pressing portion to come in contact with another part of the slide surface with the locking member at the release position.

13. The impact tool according to claim 9, further comprising:
a locking urging member configured to urge the locking member to move from the release position to the lock position.

14. The impact tool according to claim 13, wherein
the at least one button moves radially outward in response to the locking member in contact with the at least one button being urged by the locking urging member.

15. The impact tool according to claim 8, wherein
the locking member surrounds the anvil.

16. The impact tool according to claim 1, further comprising:
a support surrounding the anvil and supporting the at least one button in a movable manner.

17. The impact tool according to claim 16, further comprising:
a front anvil bearing supporting a front portion of the anvil, the front anvil bearing being supported by the support.

18. The impact tool according to claim 17, wherein
the front anvil bearing is press-fitted to a front end of the anvil.

19. The impact tool according to claim 16, further comprising:
a hammer case accommodating the hammer,
wherein the support is fixed to the hammer case.

20. The impact tool according to claim 19, further comprising:
a rear anvil bearing supporting a rear portion of the anvil, the rear anvil bearing being supported by the hammer case.
